(19) United States
(12) Patent Application Publication
(10) Pub. No.: US 2026/0169721 A1
(43) Pub. Date: Jun. 18, 2026

(54) MACHINE LEARNING BASED PROGRESSIVE DELIVERY

(71) Applicant: INTUIT INC., Mountain View, CA (US)

(72) Inventors: Avik BASU, Sunnyvale, CA (US); Saravanan BALASUBRAMANIAN, Milpitas, CA (US); Nandita KOPPISETTY, Milpitas, CA (US); Kushal BATRA, Sunnyvale, CA (US); Qianbo HUAI, Palo Alto, CA (US)

(21) Appl. No.: 18/984,295

(22) Filed: Dec. 17, 2024

(51) Int. Cl. G06F 8/65; G06F 11/14

(52) U.S. Cl. CPC G06F 8/65; G06F 11/1433

(57) ABSTRACT

The present disclosure provides techniques for machine learning based progressive delivery. One example method includes receiving record data related to an application, wherein the record data indicates one or more records, wherein each record of the one or more records indicates one or more of a timestamp, a deployment identifier, or a set of metrics, generating a sliding window for a specific deployment identifier indicated in the one or more records, generating an anomaly score indicative of a status of the application using a machine learning model associated with the application based on the sliding window, updating the anomaly score using a static bound based on the set of metrics, determining that the updated anomaly score meets a threshold value, and reverting the application to a previous status based on the determining that the updated anomaly score meets the threshold value.

### INTRODUCTION

Aspects of the present disclosure relate to machine learning based progressive delivery.

Progressive delivery, also known as progressive rollouts, is a software update strategy where new versions of software are gradually deployed to a small subset of users or environments before being made available to a broader audience. This approach allows for monitoring the performance, reliability, and user feedback of the update under controlled conditions. Progressive rollouts help organizations reduce the risk of widespread failures or user dissatisfaction while providing an opportunity to adjust as needed.

However, existing methods for progressive delivery, such as canary deployments and blue-green deployments, face certain limitations. For instance, canary deployments, where a new version is initially rolled out to a small segment of users, require careful monitoring to detect issues, which can be challenging in complex systems with noisy metrics. Similarly, blue-green deployments, where two identical environments are maintained (one running the old version and the other the new), demand significant infrastructure overhead and can result in resource inefficiencies.

Accordingly, improved systems and methods are needed for implementing progressive delivery.

### BRIEF SUMMARY

Certain embodiments provide a method for machine learning based progressive delivery.

The method generally includes receiving record data related to an application, wherein the record data indicates one or more records, wherein each record of the one or more records indicates one or more of a timestamp, a deployment identifier, or a set of metrics, generating a sliding window for a specific deployment identifier indicated in the one or more records, generating an anomaly score indicative of a status of the application using a machine learning model associated with the application based on the sliding window, updating the anomaly score using a static bound based on the set of metrics, determining that the updated anomaly score meets a threshold value, and reverting the application to a previous status based on the determining that the updated anomaly score meets the threshold value.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of the various embodiments.

### BRIEF DESCRIPTION OF DRAWINGS

The appended figures depict certain features of the various aspects described herein and are not to be considered limiting of the scope of this disclosure.

FIG. 1 depicts an example progressive delivery monitor for machine learning based progressive delivery.

FIG. 2 depicts an example process for progressive delivery monitoring.

FIG. 3 is a flow diagram of example operations for progressive delivery monitoring.

FIG. 4 depicts an example application server related to embodiments of the present disclosure.

### DETAILED DESCRIPTION

Aspects of the present disclosure provide apparatuses, methods, processing systems, and computer-readable mediums for machine learning based progressive delivery.

Application maintenance and update usually involves delivering multiple deployments (e.g., updates or versions) of an application to end users for fixing bugs or improving user experience through added features. However, when delivering new deployment that is previously not thoroughly tested to users, the undetected bugs or failure points in the new deployment may cripple the performance of the deployment, resulting in failure of the service and user dissatisfaction.

Traditional progressive delivery strategies, such as canary deployment strategies, rely heavily on expensive hand-crafted rule-based predictive systems to determine when to stop the deployment and revert the application to a previous status (e.g., the previous deployment). Furthermore, there may not be enough data to analyze the status of a new deployment, resulting in uncertain day zero experience of rolling out the new deployment.

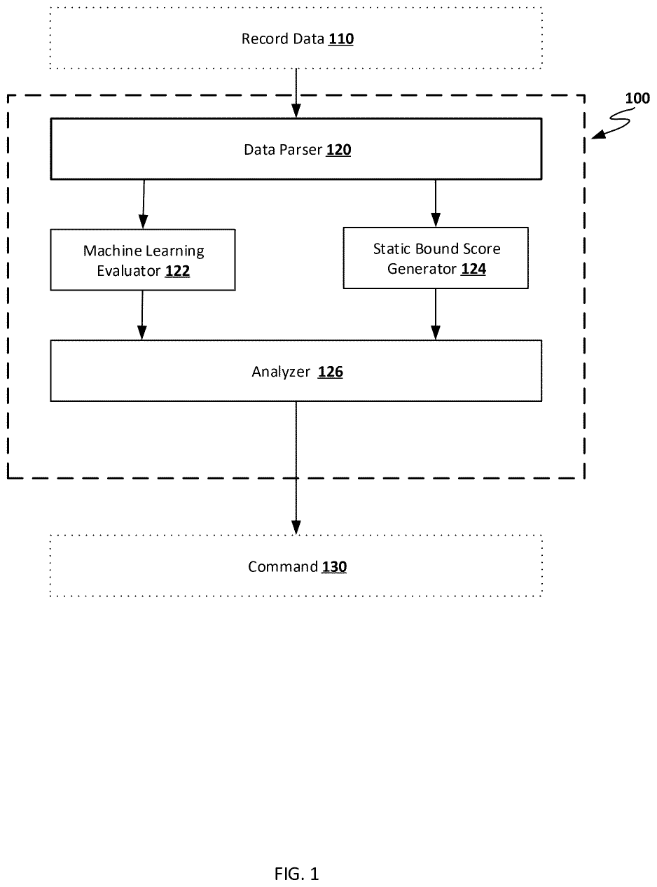

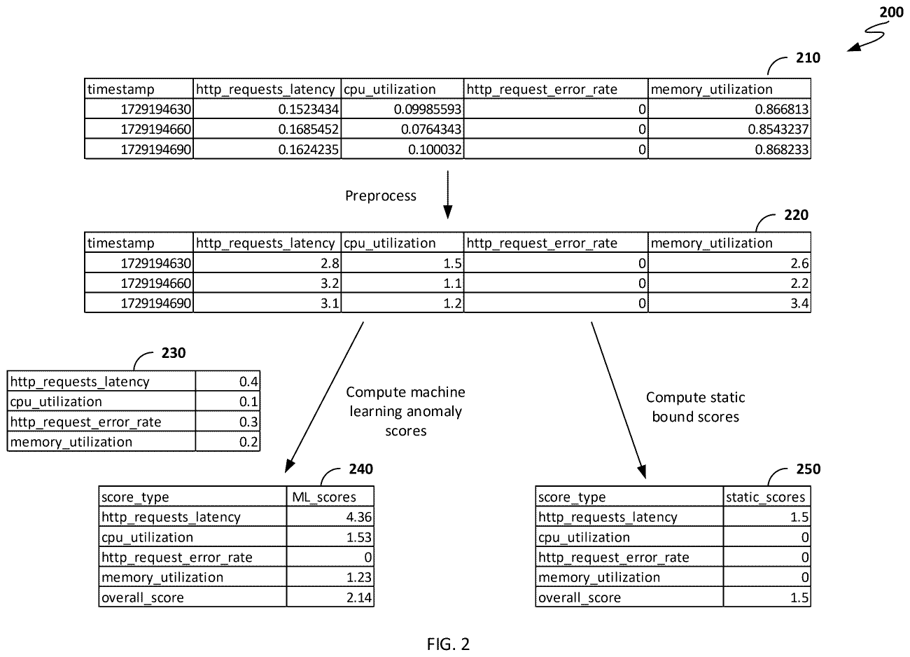

Machine learning based monitoring can help smooth progressive delivery monitoring. A machine learning model is capable of performing real-time multivariate anomaly detection simultaneously on multiple metrics and generating one anomaly score that represents the overall likelihood of failure for the current deployment. Furthermore, for explainability and interpretability, the machine learning model can generate, for each metric, a metric specific anomaly score that represents the likelihood of failure associated with the metric. Details regarding generating the anomaly score can be found below with respect to FIGS. 1-2.

The input to the machine learning model can be a sliding window of a configured size. Organizing input data in a sliding window captures the sequential pattern and facilitates evaluation by the machine learning model. Furthermore, for a new deployment of an application that lacks relevant data for analysis, data associated with the previous deployments of the application can be backfilled (e.g., included) in the sliding window to extrapolate or predict the performance of the new deployment without the need to wait for a sufficient number of data points to become available. This may be particularly beneficial for a canary deployment strategy where the evaluation can occur immediately when the new deployment rolls out. During the deployment, as the available canary data increases, the number of backfill data from the previous deployment decreases.

In combination of the machine learning based evaluation, a static thresholding technique can be included as a failsafe check. The static bound score can be designed to be a more cautious measure indicating a higher likelihood of failure when there is a poorly trained machine learning model or for a day zero experience. The static bound score helps reduce false negatives, as explained in more details below with respect to FIGS. 1-2. Furthermore, when the deployment is a new application, there may not be enough data available for training a machine learning model specific to the new application. For a smooth day zero experience, the static bound score would constitute the progressive delivery analysis until enough training data is available for the machine learning model.

By using a machine learning based progressive delivery in monitoring application deployments, techniques described herein overcome deficiencies in existing techniques for computer-based progressive delivery monitoring. For example, while existing techniques rely heavily on expensive, hand-crafted rule-based predictive systems, techniques described herein allow simultaneous monitoring of multiple distinct metrics using a machine learning model. Second, using sliding windows as the input data allows the machine learning model to more readily discover the temporal pattern present in the data. Furthermore, by introducing backfill data from previous deployments into a sliding window for a new deployment, the machine learning based analysis for the new deployment can occur immediately as the new deployment is rolled out without the need to wait for available data. Finally, including a static bound measure in the analysis makes the prediction results and decisions regarding rollout or rollback more robust, particularly if the machine learning model is poorly trained or the application is new. Thus, embodiments of the present disclosure provide a technical improvement with respect to conventional techniques for progressive delivery monitoring.

### Example Progressive Delivery Monitor for Machine Learning Based Progressive Delivery

FIG. 1 depicts an example progressive delivery monitor 100 for machine learning based progressive delivery. Progressive delivery monitor 100 can receive as input record data 110 and generate command 130 as the output. Progressive delivery monitor 100 can be deployed either online or offline.

Record data 110 may indicate one or more records related to an application (e.g., specified in the records via an application identifier). Record data 110 may be collected or retrieved from different data sources (e.g., centralized or distributed data stores or databases) and then organized (e.g., sorted according to the respective application identifier and/or timestamps of the records) prior to the receipt by progressive delivery monitor 100.

In some examples, records in record data 110 are retrieved or collected according to a configured interval (e.g. every 30 seconds). In such examples, record data 110 is organized as time series data. For simplicity, the following discussion assumes that the record data 110 is a time series.

Each record in record data 110 may further indicate one or more of a timestamp, a deployment identifier, or a set of metrics. For example, the deployment identifier can indicate a deployment or an update of an application. In some examples, the set of metrics comprises one or more of an error rate, a latency to receive a response from the application, traffic related to the application, a level of saturation related to the application, or a customized metric.

Record data 110 can be provided to data parser 120 to generate a sliding window. Data parser 120 can preprocess record data 110, such as select and organize appropriate records from record data 110, check the selected records for missing data or errors, and normalize the data in the records. Optionally, data parser 120 can reorganize the records included in the sliding window (e.g., sort according to the timestamps of the records). Details regarding sliding windows can be found below with respect to FIG. 2.

Data parser 120 can first select from record data 110 a set of most recent records (e.g., indicated by timestamps of the records) that are associated with a specific deployment identifier. The specific deployment identifier is usually the current deployment (e.g., the current version or update of the application) under analysis. For simplicity, the following discussion assumes that the specific deployment identifier indicates a current deployment.

The size of the set of most recent records corresponds to (e.g., equals or matches) a configured size of the sliding window. In an example, if the size of the sliding window is 10, 10 most recent records associated with the specific deployment identifier are selected from record data 110 to be included in the sliding window. Organizing data in a sliding window helps downstream predictive models to analyze the sequential pattern in the data.

In some examples, a deployment is recently delivered to users (e.g., pushed to a small batch of users in a canary deployment). As such, the number of records associated with the specific deployment identifier for the deployment may be lower than size of the sliding window, and the records associated with the specific deployment identifier alone may not be able to fill the sliding window.

In such examples, data parser 120 can further select (e.g., recursively) records associated with the previous deployment identifiers (e.g., indicating previous deployments) from record data 110, such that the number of records selected reaches the size of the sliding window. Usually, there would be sufficient records associated with the deployment that immediately precedes the current deployment.

For example, if the size of the sliding window is 10, where only 1 most recent record is associated with deployment B of the application, data parser 120 can further select 9 most recent records associated with deployment A, the immediate deployment preceding deployment B, to fill the sliding window, if ample records associated with deployment A are available (e.g., when deployment A is a stable deployment).

After selecting the configured number of records, data parser 120 can screen (e.g., recursively) the selected records for missing data or errors. As discussed above, a record can include information with respect to a set of metrics. If an entry with missing data related to a metric is found in a record, data parser 120 can either replace the missing data in the entry with an average value of the metric, or exclude the record associated with the entry with the missing data from the sliding window. If a record is excluded, data parser 120 can further select a most recent record that is not yet selected from record data 110 to include in the sliding window as a replacement.

For example, a record may be represented as {“timestamp”: 21, “ request_latency”: 3.1, “request_error_rate”: 0.0, “memory_utilization”: NaN}, specifically with missing data for the entry “memory_utilization”. Accordingly, data parser 120 can replace the missing data in “memory_utilization” with the average value (e.g., a mean, a median, a mode, or the like) of “memory_utilization” based on the other selected records. Alternatively, data parser 120 can exclude the defective record from the selected records (e.g., by replacing the defective record with a most recent record that is not yet selected from record data 110).

Data parser 120 can reorganize the records included in the sliding window (e.g., sort according to the timestamps of the records) if the records are not temporally arranged (e.g., when the replacement discussed above is in place).

After screening the selected records, data parser 120 can normalize the data for the records and remove outliers in the data. For example, data parser 120 can first scale the data for a metric across the records (e.g., with respect to a specific range, such as 0 to 1 or- 1 to 1), and then smooth the scaled data to remove anomalies (e.g., via exponential smoothing techniques such as exponential moving average).

The scaled and smoothened data in the sliding window facilitates easier evaluation for downstream predictive analysis because the scaled and smoothened data allows the predictive model used to quickly converge, reducing computational resources needed.

The sliding window can be provided to machine learning evaluator 122 to generate an anomaly score. Machine learning evaluator 122 may first identify a machine learning model associated with the application indicated by the records in the sliding window. For example, a machine learning model may be specific to an application (e.g., trained to evaluate the performance of the application). Accordingly, machine learning evaluator 122 passes the sliding window as input to the machine learning model to generate an anomaly score. Details regarding the anomaly score can be found below with respect to FIG. 2.

In some examples, the machine learning model include one or more of an autoencoder, a long short-term memory (LSTM) autoencoder, a convolutional neural network (CNN), a recurrent neural network (RNN), or a variational autoencoder (VAE). These are included as examples, and other suitable types of machine learning models may be used.

Furthermore, the machine learning model may generate a metric specific anomaly score for each metric based on the data in the sliding window. The metric specific anomaly scores can be combined (e.g., via weighted averaging) to calculate the anomaly score.

In some examples, additionally, the anomaly score (or the metric specific anomaly score discussed above) is normalized according to a configured range (e.g., 0 to 1) for explainability when presented to an operator (e.g., someone monitoring the deployment, such as an engineer).

In some examples, additionally, the machine learning model includes a layer (e.g., a sigmoid layer, a softmax layer, or the like) that can generate binary output indicating whether the output is anomalous or non-anomalous.

In some examples, alternatively, the machine learning model specific to the application is not available (e.g., has not been created or trained), and the anomaly score generated is then disregarded (e.g., set as zero).

Machine learning evaluator 122 may also check whether retraining is needed for the machine learning model according to a configured frequency (e.g., every month) based on several conditions. The retraining may be necessary when one of the several conditions is satisfied, such as that the model has not been retrained for a prolonged period of time (e.g., meeting a threshold time period), that a significant data drift is observed in the current deployment data from historical data (e.g., based on a threshold Kullback- Leibler (KL) divergence of the distribution of the data in the current deployment from the distribution of historical data), or that a change in the model configuration occurs and requires a new model with the new configuration to be retrained.

To retrain the model, historical data associated with the application from data storage can be retrieved, cleaned, normalized and smoothed, as discussed above with respect to data parser 120. The model can be retrained (e.g., iteratively until the model converges) based on the processed historical data according to a model configuration. The retrained model may then be saved or stored for future use.

The sliding window can be provided to static bound score generator 124 to generate a static bound score. Although the static bound score generator 124 is depicted as a parallel of machine learning evaluator 122, static bound score can be generated in series with (e.g., before or after) the anomaly score generated by machine learning evaluator 122. In some examples, the static bound score is generated based on one most recent record in the sliding window instead of all data in the sliding window.

Static bound score generator 124 can use a static thresholding technique (e.g., a sigmoid function, a smoothened step function, or the like) to generate static bound score. Static bound score may be generated via performing static thresholding on each metric in the sliding window. The thresholds can be set via various ways, such as the model configuration or an optimal value (e.g., a maximum, a convex combination of a mean and a standard deviation, and/or the like) based on a statistical analysis of the historic data. In some examples, the static bound score is in the same range output as the anomaly score generated by machine learning evaluator 122. Details regarding the static bound score can be found below with respect to FIG. 2.

In an example, for the error rate metric with a threshold of 0.04 with a range of static bound score between 0 and 1, any data point in the sliding window with an error rate greater than 0.04 would have a static bound score of 1 (the maximum value), while any data point with an error rate less than 0.04 will have a static bound score of 0 (the minimum).

Because the static bound score is designed to be a more cautious measure, it can be regarded as a failsafe check to safeguard against poorly trained machine learning models or for a smooth day zero experience. First, models may be trained using poor quality data, such as when the training data includes anomalies or when the upstream data generation has problems. The static bound score helps reduce false negatives, as explained in more details below. Second, when a new application is recently deployed, few records associated with the application are available and there would not be enough data to train a machine learning model specific to the application. For a smooth day zero experience, the static bound score would constitute the progressive delivery analysis until enough training data is available for the machine learning model.

The anomaly score and the static bound score can be provided to analyzer 126 to generate command 130. Command 130 can include a binary indication of whether to rollout (e.g., continue deployment of the current deployment) or rollback (e.g., revert to a previous deployment).

The anomaly score and the static bound score can be combined (e.g., through a maximum, a mean, a convex combination, or another type of aggregation) to generate a unified score. The unified score can indicate the likelihood of failure for the current deployment.

Including the static bound score in calculating the unified score may reduce false negatives as the static bound score usually indicates a higher likelihood of failure than the anomaly score. In an example, if a deployment is recent, the failure rate may be high and the machine learning model may regard the high failure rate as typical so that the anomaly score generated would not necessarily indicate a high likelihood of failure. In the example, a static bound score indicating a high likelihood of failure would make the unified score correctly indicate a high likelihood of failure for the deployment.

Command 130 can have a default value indicating rollout. In some examples, if the unified score meets a threshold value (e.g., 5 for a scale between 0 and 10), command 130 is set to rollback. In some examples, alternatively, command 130 is set to rollback if the computed unified score meets the threshold value for a threshold consecutive number of times (e.g., 3).

### Example Process for Monitoring Progressive Delivery

FIG. 2 depicts an example process 200 for monitoring progressive delivery. Process 200 can be performed by a progressive delivery monitor, such as progressive delivery monitor 100 as shown in FIG. 1.

Process 200 starts by generating sliding window 210. Sliding window 210 may be generated by a data parser, such as data parser 120 as shown in FIG. 1. The data parser can retrieve data stored in various data stores and aggregate the data in sliding window 210. Although the sliding window 210 is shown as a matrix, sliding window 210 can be represented using other appropriate data structures, such as a dictionary, a nested list, a Pandas DataFrame, and/or the like.

In this example, as depicted, sliding window 210 has a size of 3, where each row corresponds to a record and each record indicates a set of metrics, such as in a manner similar to that described with respect to FIG. 1. In this example, the metrics include “timestamp,” “http_requests_latency,” “cpu_utilization,” “http_request_error_rate,” and “memory_utilization.” Furthermore, in this example, the records are arranged temporally, with the first record (e.g., the first row) represents the earliest (e.g., the least recent) while the last record (e.g., the last row) representing the latest (e.g., the most recent). As depicted, in this example, there is a same interval (e.g., 30) between timestamps for two consecutive records in sliding window 210, the intervals may differ if a replacement record is included in the sliding window, as described with respect to FIG. 1.

Sliding window 210 can then be cleaned, normalized, and smoothed to generate preprocessed sliding window 220, as described with respect to FIG. 1. In this example, the relevant data entries are scaled based on a range from 0 to 10, but other appropriate ranges or scales can be used. In this example, the metric “timestamp” is not scaled because it serves as a marker (e.g., represents a row number) for the data and would not be evaluated by downstream predictive systems.

Preprocessed sliding window 220 can be taken as input by a machine learning model, such as one identified by machine learning evaluator 122 as shown in FIG. 1. In some examples, alternatively, the machine learning model takes as input sliding window 210 instead of preprocessed sliding window 220.

The machine learning model can first generate, for each relevant metric, a metric specific anomaly score. In this example, metric specific anomaly scores are generated for “http_requests_latency,” “cpu_utilization,” “http_request_error_rate,” and “memory_utilization.” The machine learning metric specific anomaly scores can be combined to generate an overall machine learning anomaly score. In this example, the metric specific anomaly scores are combined via weighted average, with weights 230.

In this example, the metric specific anomaly scores and overall machine learning anomaly score from the machine learning model are depicted as machine learning scores 240.

Preprocessed sliding window 220 can also be taken as input by a static bound score generator, such as static bound score generator 124, as shown in FIG. 1. In some examples, alternatively, the static bound score generator takes as input sliding window 210 instead of preprocessed sliding window 220.

The static bound score generator can first generate, for each relevant metric, a metric specific anomaly score. In this example, metric specific anomaly scores are generated for “http_requests_latency,” “cpu_utilization,” “http_request_error_rate,” and “memory_utilization.” The static bound metric specific anomaly scores can be combined to generate an overall score. In this example, the overall static bound score generated by the static bound score generator is the maximum of the metric specific anomaly scores, but other appropriate statistical measures (e.g., a mean or a convex combination) can also be used.

The metric specific anomaly scores and overall static bound score from the static bound score generator are depicted as static bound scores 250.

The overall scores from machine learning scores 240 and static bound scores 250 can be combined to generate a unified score, such as in a similar manner to that described with respect to FIG. 1. In this example, the unified score is the maximum (e.g., 2.14) of the overall machine learning anomaly score from machine learning scores 240 and the overall static bound score from static bound scores 250, but other appropriate statistical measures (e.g., a mean or a convex combination) can also be used.

The unified score can be used by an analyzer, such as analyzer 126, to generate a command, such as 130 as shown in FIG. 1. In some examples, if the unified score meets a threshold value (e.g., 4), the analyzer switches the command from rollout to rollback. In some examples, alternatively, if the computed unified score meets the threshold value for a consecutive number of times (e.g., 3), the analyzer switches the command from rollout to rollback.

### Example Operations for Monitoring Progressive Delivery

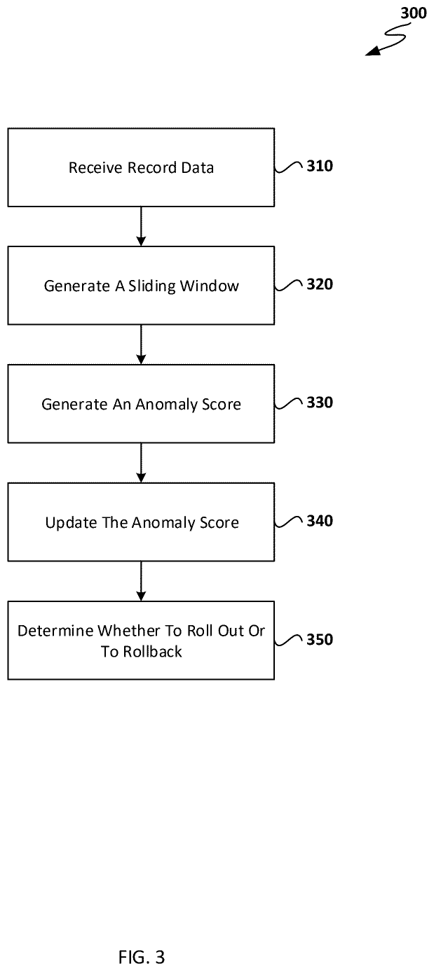

FIG. 3 is a flow diagram of example operations 300 for progressive delivery monitoring. Operations 300 may be performed by a progressive delivery monitor, such as progressive delivery monitor 100 as illustrated in FIG. 1.

Operations 300 begin at 310, where record data related to an application is received, wherein the record data indicates one or more records, wherein each record of the one or more records indicates one or more of a timestamp, a deployment identifier, or a set of metrics. For example, the record data can be record data 110 as illustrated in FIG. 1.

In some embodiments, the set of metrics comprises one or more of an error rate, a latency to receive a response from the application, traffic related to the application, a level of saturation related to the application, or a customized metric. For example, the set of metrics can be the set of metrics as described with respect to FIG. 2.

At 320, a sliding window is generated for a specific deployment identifier indicated in the one or more records, comprising identifying a set of most recent records associated with the deployment identifier, wherein a size of the set of most recent records corresponds to a configured number; and sorting the set of most recent records based on the timestamp associated with each record in the set of most recent records. For example, the sliding window can be generated by data parser 120 as illustrated in FIG. 1 and can be similar to or the same as sliding window 210 or preprocessed sliding window 220 as illustrated in FIG. 2.

In some embodiments, an entry with missing data related to a metric of the set of metrics is identified in the sliding window. Accordingly, the missing data in the entry can be replaced with an average of the metric related to the entry or the record associated with the entry with the missing data excluded from the sliding window. If the record is excluded, a replacement record from the record data can be included in the sliding window, as described with respect to FIG. 1. Furthermore, if the temporal relationship between the records in the sliding window is broken, the records can be reorganized (e.g., sorted according to the timestamps of the records), as described with respect to FIG. 1.

In such embodiments, additionally, entries related to the set of metrics in the sliding window are normalized with respect to each metric in the set of metrics, and exponential smoothing is applied to the entries related to the set of metrics in the sliding window, as described with respect to FIG. 1.

In some embodiments, a difference is determined to exist between a number of records in the sliding window and the configured number, wherein the number of records is smaller than the configured number, a set of records indicating a previous deployment identifier associated with the application is then identified, wherein a corresponding size of the set of records corresponds to the difference, and the set of records associated with the previous deployment identifier is included in the sliding window. For example, the set of records indicating a previous deployment identifier can be a set of recursively selected records associated with the previous deployment identifiers, as described with respect to FIG. 1.

At 330, an anomaly score indicative of a status of the application is generated using a machine learning model associated with the application based on the sliding window. For example, the anomaly score can be the anomaly score as described with respect to FIG. 1 or the overall score from machine learning scores 240 as illustrated in FIG. 2, which can be generated using a machine learning model, such as one identified by machine learning evaluator 122 as shown in FIG. 1.

In some embodiments, the machine learning model associated with the application is determined to be not available, and the anomaly score generated is then set to zero based on the determining that the machine learning model associated with the application is not available, as described with respect to FIG. 1.

In some embodiments, a metric anomaly score is generated for each metric in the set of metrics, each metric anomaly score is normalized based on a configured range; and the normalized metric anomaly scores are presented to an operator. The metric anomaly score can be the metric specific anomaly scores as described with respect to FIG. 1 or the machine learning metric specific anomaly scores as described with respect to FIG. 2.

In some embodiments, the machine learning model comprises one or more of an autoencoder, a long short-term memory (LSTM) autoencoder, a convolutional neural network (CNN), a recurrent neural network (RNN), or a variational autoencoder (VAE).

At 340, the anomaly score is updated using a static bound based on the set of metrics. For example, the static bound can be the static bound score as described with respect to FIG. 1 or the overall score from static bound scores 250 as illustrated in FIG. 2. For example, the updated anomaly score can be the unified score as described with respect to FIGS. 1-2.

In some embodiments, the static bound is based on one or more of a sigmoid function or a step function.

At 350, the updated anomaly score is determined to meet a threshold value and the application is reverted to a previous status (e.g., a previous deployment) based on the determining that the updated anomaly score meets the threshold value. The reverting can be based on a command, such as command 130 as illustrated in FIG. 1.

In some embodiments, alternatively, the reverting is performed if the updated anomaly score meets the threshold value for a consecutive number of times, as described with respect to FIGS. 1-2.

### Example Application Server

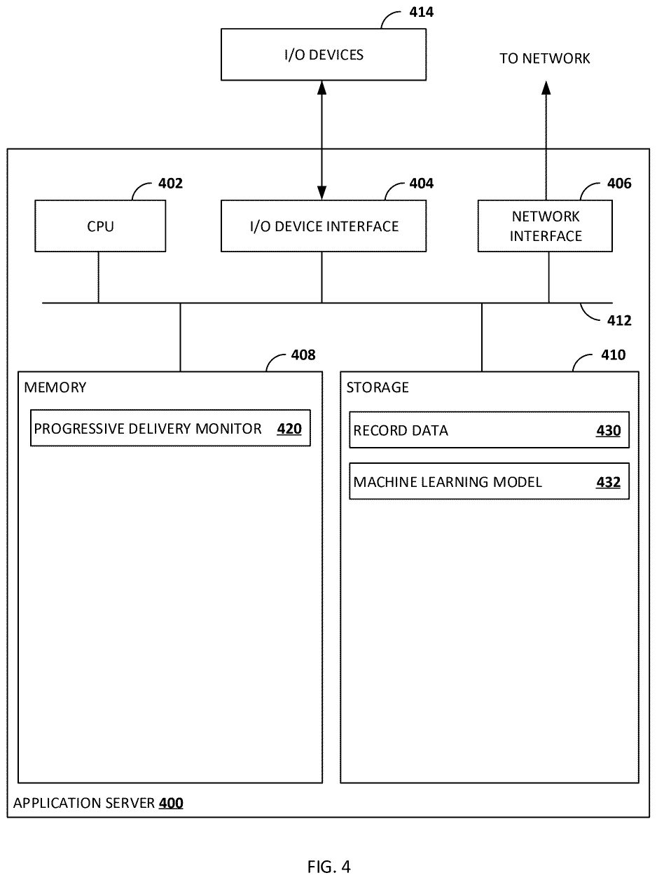

FIG. 4 depicts an example application server 400, which can be used to deploy progressive delivery monitor 100 of FIG. 1. As shown, application server 400 includes a central processing unit (CPU) 402, one or more input/output (I/O) device interfaces 404, which may allow for the connection of various I/O devices 414 (e.g., keyboards, displays, mouse devices, pen input, etc.) to application server 400, a network interface 406, a memory 408, a storage 410, and an interconnect 412.

CPU 402 may retrieve and execute programming instructions stored in memory 408. Similarly, CPU 402 may retrieve and store application data residing in memory 408. Interconnect 412 transmits programming instructions and application data, among CPU 402, I/O device interface 404, network interface 406, memory 408, and storage 410. CPU 402 is included to be representative of a single CPU, multiple CPUs, a single CPU having multiple processing cores, and the like. I/O device interface 404 may provide an interface for capturing data from one or more input devices integrated into or connected to application server 400, such as keyboards, mice, touchscreens, and so on. Memory 408 may represent a random access memory (RAM), while storage 410 may be a solid state drive, for example. Although shown as a single unit, storage 410 may be a combination of fixed and/or removable storage devices, such as fixed drives, removable memory cards, network attached storage (NAS), or cloud-based storage.

As shown, memory 408 includes progressive delivery monitor 420. Progressive delivery monitor 420 may be the same as or substantially similar to progressive delivery monitor 100 of FIG. 1.

As shown, storage 410 includes record data 430 and machine learning model 432. Record data 430 may be the same as or substantially similar to record data 110 while machine learning model 432 may be the same as or substantially similar to a machine learning model as described with respect to FIGS. 1-2.

It is noted that the components depicted in application server 400 are included as examples, and other types of computing components may be used to implement techniques described herein. For example, while memory 408 and storage 410 are depicted separately, components depicted within memory 408 and storage 410 may be stored in the same storage device or different storage devices associated with one or more computing devices.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

What is claimed is:

1. A method, comprising:
receiving record data related to an application, wherein the record data indicates one or more records, wherein each record of the one or more records indicates one or more of a timestamp, a deployment identifier, or a set of metrics;
generating a sliding window for a specific deployment identifier indicated in the one or more records, comprising:
identifying a set of most recent records associated with the deployment identifier, wherein a size of the set of most recent records corresponds to a configured number; and
sorting the set of most recent records based on the timestamp associated with each record in the set of most recent records;
generating an anomaly score indicative of a status of the application using a machine learning model associated with the application based on the sliding window;
updating the anomaly score using a static bound based on the set of metrics;
determining that the updated anomaly score meets a threshold value; and
reverting the application to a previous status based on the determining that the updated anomaly score meets the threshold value.

2. The method of claim 1, wherein the set of metrics comprises one or more of an error rate, a latency to receive a response from the application, traffic related to the application, a level of saturation related to the application, or a customized metric.

3. The method of claim 1, further comprising:
identifying an entry with missing data related to a metric of the set of metrics in the sliding window;
performing one of:
replacing the missing data in the entry with an average of the metric related to the entry; or
excluding a record associated with the entry with the missing data from the sliding window;
normalizing entries related to the set of metrics in the sliding window with respect to each metric in the set of metrics; and
applying exponential smoothing to the entries related to the set of metrics in the sliding window.

4. The method of claim 1, further comprising:
determining that a difference exists between a number of records in the sliding window and the configured number, wherein the number of records is smaller than the configured number;
identifying a set of records indicating a previous deployment identifier associated with the application, wherein a corresponding size of the set of records corresponds to the difference; and
including in the sliding window, the set of records associated with the previous deployment identifier.

5. The method of claim 1, further comprising:
determining that the machine learning model associated with the application is not available; and
setting the anomaly score generated to zero based on the determining that the machine learning model associated with the application is not available.

6. The method of claim 1, wherein the machine learning model comprises one or more of an autoencoder, a long short-term memory (LSTM) autoencoder, a convolutional neural network (CNN), a recurrent neural network (RNN), or a variational autoencoder (VAE).

7. The method of claim 1, further comprising:
generating, for each metric in the set of metrics, a metric anomaly score;
normalizing each metric anomaly score based on a configured range; and
presenting the normalized metric anomaly scores to an operator.

8. The method of claim 1, wherein the static bound is based on one or more of a sigmoid function or a step function.

9. A system, comprising:
a memory including computer executable instructions; and
a processor configured to execute the computer executable instructions and cause the system to:
receive record data related to an application, wherein the record data indicates one or more records, wherein each record of the one or more records indicates one or more of a timestamp, a deployment identifier, or a set of metrics;
generate a sliding window for a specific deployment identifier indicated in the one or more records, comprising:
identifying a set of most recent records associated with the deployment identifier, wherein a size of the set of most recent records corresponds to a configured number; and
sorting the set of most recent records based on the timestamp associated with each record in the set of most recent records;
generate an anomaly score indicative of a status of the application using a machine learning model associated with the application based on the sliding window;
update the anomaly score using a static bound based on the set of metrics;
determine that the updated anomaly score meets a threshold value; and
revert the application to a previous status based on the determining that the updated anomaly score meets the threshold value.

10. The system of claim 9, wherein the set of metrics comprises one or more of an error rate, a latency to receive a response from the application, traffic related to the application, a level of saturation related to the application, or a customized metric.

11. The system of claim 9, wherein the processor is further configured to execute the computer executable instructions and cause the system to:
identify an entry with missing data related to a metric of the set of metrics in the sliding window;
perform one of:
replace the missing data in the entry with an average of the metric related to the entry; or
exclude a record associated with the entry with the missing data from the sliding window;
normalize entries related to the set of metrics in the sliding window with respect to each metric in the set of metrics; and
apply exponential smoothing to the entries related to the set of metrics in the sliding window.

12. The system of claim 9, wherein the processor is further configured to execute the computer executable instructions and cause the system to:
determine that a difference exists between a number of records in the sliding window and the configured number, wherein the number of records is smaller than the configured number;
identify a set of records indicating a previous deployment identifier associated with the application, wherein a corresponding size of the set of records corresponds to the difference; and
include in the sliding window, the set of records associated with the previous deployment identifier.

13. The system of claim 9, wherein the processor is further configured to execute the computer executable instructions and cause the system to:
determine that the machine learning model associated with the application is not available; and
set the anomaly score generated to zero based on the determining that the machine learning model associated with the application is not available.

14. The system of claim 9, wherein the machine learning model comprises one or more of an autoencoder, a long short-term memory (LSTM) autoencoder, a convolutional neural network (CNN), a recurrent neural network (RNN), or a variational autoencoder (VAE).

15. The system of claim 9, wherein the processor is further configured to execute the computer executable instructions and cause the system to:
generate, for each metric in the set of metrics, a metric anomaly score;
normalize each metric anomaly score based on a configured range; and
present the normalized metric anomaly scores to an operator.

16. The system of claim 9, wherein the static bound is based on one or more of a sigmoid function or a step function.

17. A non-transitory computer readable medium comprising instructions to be executed in a computer system, wherein the instructions when executed in the computer system cause the computer system to:
receive record data related to an application, wherein the record data indicates one or more records, wherein each record of the one or more records indicates one or more of a timestamp, a deployment identifier, or a set of metrics;
generate a sliding window for a specific deployment identifier indicated in the one or more records, comprising:
identifying a set of most recent records associated with the deployment identifier, wherein a size of the set of most recent records corresponds to a configured number; and
sorting the set of most recent records based on the timestamp associated with each record in the set of most recent records;
generate an anomaly score indicative of a status of the application using a machine learning model associated with the application based on the sliding window;
update the anomaly score using a static bound based on the set of metrics;
determine that the updated anomaly score meets a threshold value; and
revert the application to a previous status based on the determining that the updated anomaly score meets the threshold value.

18. The non-transitory computer readable medium of claim 17, wherein the set of metrics comprises one or more of an error rate, a latency to receive a response from the application, traffic related to the application, a level of saturation related to the application, or a customized metric.

19. The non-transitory computer readable medium of claim 17, wherein the machine learning model comprises one or more of an autoencoder, a long short-term memory (LSTM) autoencoder, a convolutional neural network (CNN), a recurrent neural network (RNN), or a variational autoencoder (VAE).

20. The non-transitory computer readable medium of claim 17, wherein the static bound is based on one or more of a sigmoid function or a step function.
